(19) United States
(12) Patent Application Publication
(10) Pub. No.: US 2017/0297412 A1
(43) Pub. Date: Oct. 19, 2017

(54) METHOD OF CONTROLLING A HVAC SYSTEM OF A VEHICLE

(71) Applicant: GM GLOBAL TECHNOLOGY OPERATIONS LLC, Detroit, MI (US)

(72) Inventors: Pulasti Bandara, Clinton Township, MI (US); Maqsood Rizwan Ali Khan, Rochester Hills, MI (US); Mark R. Claywell, Birmingham, MI (US)

(73) Assignee: GM GLOBAL TECHNOLOGY OPERATIONS LLC, Detroit, MI (US)

(21) Appl. No.: 15/097,401

(22) Filed: Apr. 13, 2016

(51) Int. Cl. B60H 1/00; B60S 1/02; B60S 1/54

(52) U.S. Cl. CPC B60H 1/00785; B60S 1/54; B60H 1/00842; B60S 1/023

(57) ABSTRACT

A method of controlling a HVAC system of a vehicle includes repeatedly sensing an area of a window of the vehicle that is not covered by frost with a sensor positioned adjacent the window. When the sensed area not covered by frost is less than an area threshold value, a HVAC controller controls the HVAC system to operate in a defrost mode. When the sensed area not covered by frost is equal to or greater than the area threshold value the HVAC controller controls the HVAC system to operate in a cabin heating mode. The HVAC controller automatically switches the HVAC system from the defrost mode to the cabin heating mode when the sensed area not covered by frost increases to a value that is equal to or greater than the area threshold value.

### TECHNICAL FIELD

The disclosure generally relates to a method of controlling an HVAC system of a vehicle.

### BACKGROUND

Most vehicles include a Heating Ventilation Air Conditioning (HVAC) system that is at least operable in a defrost mode and/or a cabin heating mode. When controlled to operate in the defrost mode, the HVAC system directs a flow of heated air directly onto an interior surface of the windows to dissipate frost that may have formed on an exterior surface of the windows, and/or dissipate condensation that may have formed on an interior surface of the window. When controlled to operate in the cabin heating mode, the HVAC system directs a flow of heated air into a passenger cabin of the vehicle to warm the air within the passenger cabin to a desired cabin temperature. The HVAC system may also be controlled to operate in a split mode, in which both the defrost mode and the cabin heating mode are simultaneously applied. In so doing, a portion of the flow of heated air is directed onto the windows to defog/defrost the windows, and another portion of the flow of heated air is directed into the cabin to heat the cabin air to the desired cabin temperature.

### SUMMARY

A method of controlling a Heating Ventilation Air Conditioning (HVAC) system of a vehicle is provided. The method includes repeatedly sensing an area of a window of the vehicle that is not covered by frost with a sensor positioned adjacent the window. When the sensed area not covered by frost is less than an area threshold value, a HVAC controller controls the HVAC system to operate in a defrost mode. When the sensed area not covered by frost is equal to or greater than the area threshold value the HVAC controller controls the HVAC system to operate in a cabin heating mode. The HVAC controller automatically switches the HVAC system from the defrost mode to the cabin heating mode when the sensed area not covered by frost increases to a value that is equal to or greater than the area threshold value.

A vehicle is also provided. The vehicle includes a body defining a passenger cabin, and including a window. The vehicle further includes a HVAC system that is operable in a defrost mode for defrosting the window, or in a cabin heating mode for heating the passenger cabin. An optical sensor is positioned adjacent the window, within the passenger cabin. The optical sensor is operable to sense light through the window. A light source is attached to the body, outside of the passenger cabin, and is positioned to emit light through the window. A HVAC controller is disposed in communication with the optical sensor, such that the optical sensor is operable to sense data related to light emitted from the light source and transmitted through the window, and communicate the sensed data to the HVAC controller. The HVAC controller includes a processor and tangible, non-transitory memory on which are recorded computer-executable instructions, including an HVAC control algorithm. The HVAC control algorithm is operable on the processor to calculate a percentage of the window that is covered by frost, based on the sensed data received from the optical sensor. The HVAC control algorithm automatically controls the HVAC system to operate in one of the defrost mode or the cabin heating mode based on the calculated percentage of the window covered by frost.

Accordingly, the HVAC controller receives data from the sensor adjacent the window, and uses that data to calculate a percentage of the window that is covered by frost. The HVAC controller then automatically determines whether to operate the HVAC system in the defrost mode or the cabin heating mode based on the calculated percentage of the window not covered by frost. As the calculated percentage changes, i.e., increases, to a percentage equal to or greater than the area threshold value, then the HVAC controller may automatically switch the operation of the HVAC system from the defrost mode to the cabin heating mode. By automatically switching the HVAC system from the defrost mode to the cabin heating mode as soon as the window has been defrosted to an appropriate degree, instead of allowing the defrost mode to operate for a period of time after the window has been defrosted, thermal energy is directed to warming the cabin air more quickly, thereby reducing the time required to heat the cabin air to the desired cabin temperature.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic side view of a vehicle.

FIG. 2 is a schematic plan view of a windshield of the vehicle, showing a portion of the windshield covered in frost, and a portion of the windshield not covered in frost.

FIG. 3 is a flowchart representing a method of controlling a HVAC system of the vehicle.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

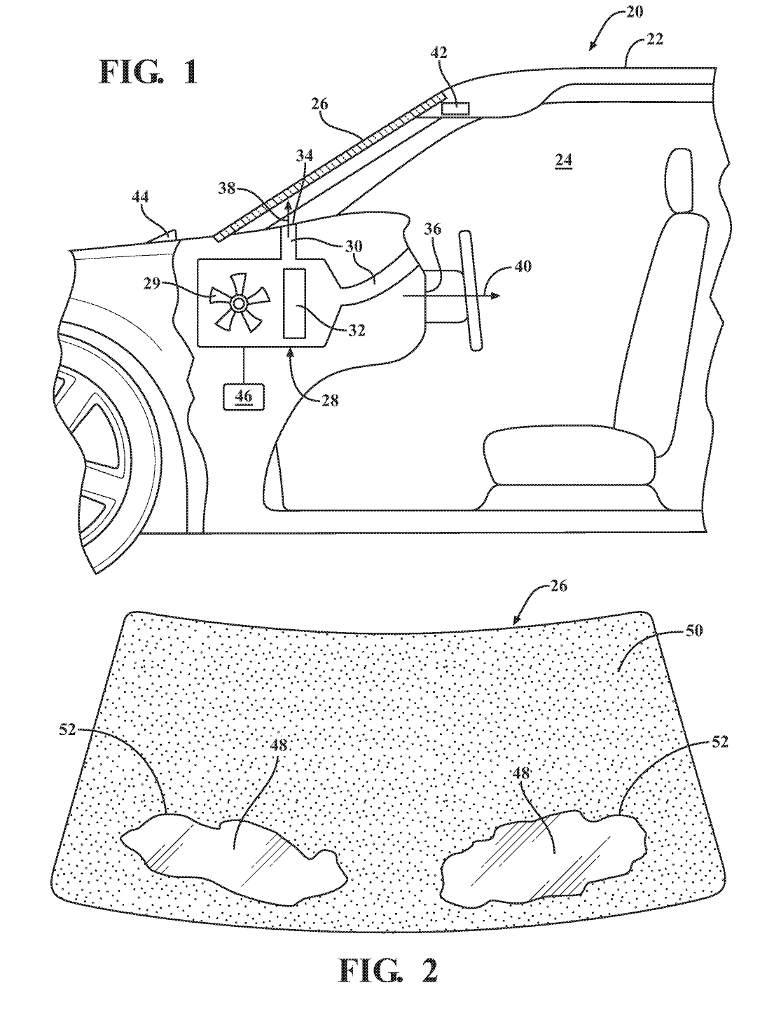

Referring to the Figures, wherein like numerals indicate like parts throughout the several views, a vehicle is generally shown at 20 in FIG. 1. The vehicle 20 may include any style and/or configuration that includes a body 22 defining a passenger cabin 24. The body 22 includes a window 26. As shown in the exemplary embodiment of FIG. 1, the window 26 is a front windshield. However, it should be appreciated that the window 26 may include a side facing window 26 or a rear facing window 26.

The vehicle 20 further includes a Heating Ventilation Air Conditioning (HVAC) system 28. The HVAC system 28 includes, but is not limited to, a fan 29 for moving a flow of air through a system of ducts 30, a heating core 32 for exchanging heat from an engine coolant to the flow of air, and an evaporator (not shown) for removing heat from the flow of air. The system of ducts 30 includes one or move valves, flaps, or other similar control devices to control the flow of air between different outlets. For example, the system of ducts 30 includes at least one defrost outlet 34 disposed adjacent the window 26 for directing the flow of air directly onto the window 26. The system of ducts 30 also includes at least one cabin outlet 36 positioned to direct the flow of air into the passenger cabin 24 for heating and/or cooling the air within the passenger cabin 24.

The HVAC system 28 is operable in at least a defrost mode and a cabin heating mode. It should be appreciated that the HVAC system 28 may be operable in other modes not described herein. When the HVAC system 28 is controlled to operate in the defrost mode, the system of ducts 30 directs the flow of air through the heating core 32 to draw heat from an engine coolant, and then direct the flow of heated air onto the window 26, generally indicated by arrow 38, to either defrost an exterior surface of the window 26, and/or defog an interior surface of the window 26. When the HVAC system 28 is controlled to operate in the cabin heating mode, the system of ducts 30 directs the flow of air through the heating core 32 to draw heat from the engine coolant, and then directs the flow of heated air into the passenger cabin 24, generally indicated by arrow 40, for heating the passenger cabin 24 to a desired cabin temperature. The cabin heating mode may include any HVAC operating mode that does not directly direct a flow of air onto the window 26 for the purpose of defrosting the window 26. For example, the cabin heating mode may direct the flow of heated air toward a passenger foot area through a lower outlet, or toward a passenger torso area through a panel or dash mounted outlet. It should be appreciated that the cabin heating mode may include other heating mode options that are not specifically noted or described herein. The HVAC system 28 may be operated in a split mode, in which a portion of the flow of heated air is directed onto the window 26, i.e., the defrost mode, and another portion of the flow of heated air is simultaneously directed into the passenger cabin 24, i.e., the cabin heating mode.

The vehicle 20 further includes a sensor 42. The sensor 42 is positioned adjacent the window 26, within the passenger cabin 24. In an exemplary embodiment, the sensor 42 is operable to sense light and/or objects through the window 26. In the exemplary embodiment shown in FIG. 1, the sensor 42 is positioned as a forward facing sensor 42 for sensing objects and/or light through the front windshield of the vehicle 20. The sensor 42 may include, but is not limited to an optical sensor 42 such as a camera or light sensor 42. For example, in one exemplary embodiment, the sensor 42 may include a forward facing camera used to detect objects in front of the vehicle 20 and/or lane lines. It should be appreciated that in addition to the method described below, the sensor 42 may be used to perform some other function associated with the control of the vehicle 20, such as object avoidance or lane correction. Furthermore, it should be appreciated that the sensor 42 may include some other manner or type of sensor, such as a capacitance sensor on the window 26. The sensor 42 should therefore not be limited to the exemplary embodiments of the optical sensor (e.g., a camera or a light sensor) or the capacitance sensor described herein. Rather, the term “sensor” should be interpreted broadly to include any type of sensor that is capable of sensing data that the HVAC controller 46 may use to calculate the percentage of the window 26 that is covered by frost.

If the sensor 42 is a light sensor 42, it may be necessary to equip the vehicle 20 with a light source 44 that is attached to the body 22, outside of the passenger cabin 24, and positioned to emit light through the window 26, into the interior of the passenger cabin 24 and onto the sensor 42, so that the sensor 42 may detect the light passing through the window 26. For example, if the sensor 42 is an infrared light sensor 42, an infrared light source 44 may be placed outside the passenger cabin 24 to shine through the window 26. Such an optical sensor 42 would be operable to sense data related to the light emitted from the light source 44, and transmitted through the window 26.

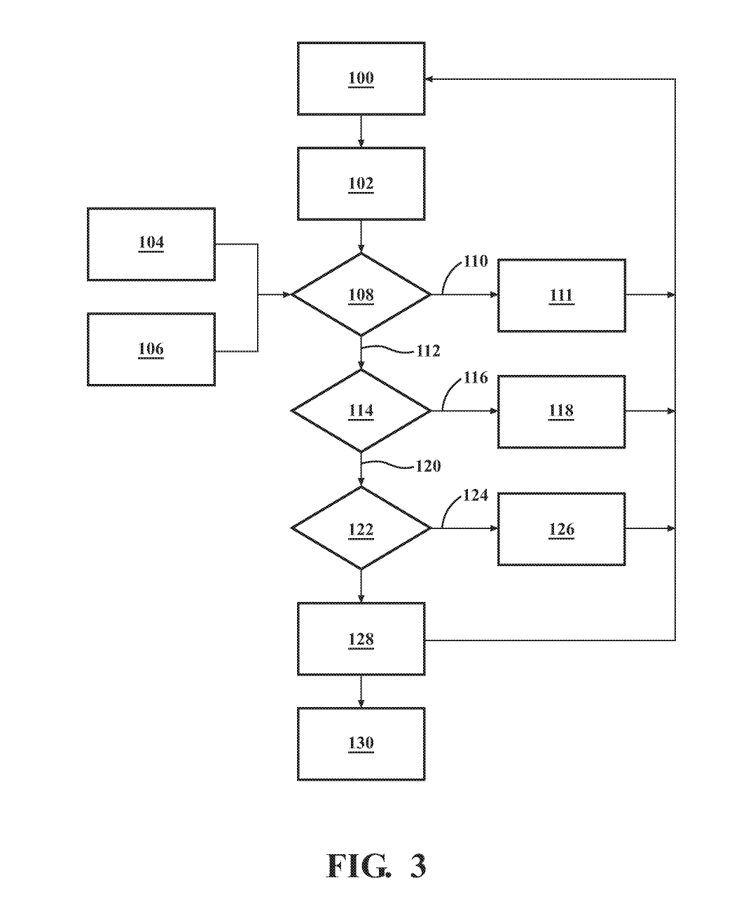

The vehicle 20 further includes a HVAC controller 46. The HVAC controller 46 is disposed in communication with the sensor 42, with the sensor 42 communicating sensed data to the HVAC controller 46. The HVAC controller 46 is operable to control the HVAC system 28, at least partially on the data sensed by the sensor 42. The HVAC controller 46 may include a computer and/or processor, and include all software, hardware, memory, algorithms, connections, sensor 42s, etc., necessary to manage and control the operation of the HVAC system 28. As such, a method, described below and generally shown in FIG. 3, may be embodied as a program or algorithm operable on the HVAC controller 46. It should be appreciated that the HVAC controller 46 may include any device capable of analyzing data from various sensors 42, comparing data, making the necessary decisions required to control the operation of the HVAC system 28, and executing the required tasks necessary to control the operation of the HVAC system 28.

The HVAC controller 46 includes a tangible non-transitory memory having computer executable instructions recorded thereon, including a HVAC control algorithm. The controller further includes a processor that is operable to execute the HVAC control algorithm to control the HVAC system 28 between the defrost mode, the cabin heating mode, and/or the split mode. The HVAC control algorithm uses the data from the vehicle sensor(s) 42 to determine the percentage of the window 26 that is covered by frost, and control the HVAC system 28 between the defrost mode and the cabin heating mode based on the percent of the window 26 covered by frost.

The HVAC controller 46 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory may include any non-transitory/tangible medium which participates in providing data or computer-readable instructions. Memory may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

The HVAC controller 46 includes a processor and tangible, non-transitory memory on which are recorded computer-executable instructions, including the HVAC control algorithm. The HVAC control algorithm implements the method of controlling the HVAC system 28 described below. Referring to FIG. 3, the method includes continuously or repeatedly sensing an area of a window 26 of the vehicle 20 that is not covered by frost, with the sensor 42 positioned adjacent the window 26. Sensing the area of the window 26 not covered by frost is generally indicated by box 100 in FIG. 3. Referring to FIG. 2, the area of the window 26 that is not covered by frost is generally shown as the clear portion 48 of the window 26, and the area of the window 26 that is covered by frost is generally shown as the hatched portion 50 of the window 26. The sensor 42 may sense data related to the area of the window 26 not covered by frost in any suitable manner. Because the frost operates to block, at least to a certain degree, light transmission through the window 26, the portions of the window 26 that are covered by frost and the portions of the window 26 that are not covered by frost will transmit different levels of light through the window 26. Accordingly, the sensor 42 may be programmed to detect portions of the window 26 that transmit a high degree of light therethrough, such as where no frost is present in area 48, and other portions of the window 26 that transmit less light therethrough, such as where frost is present in area 50. This data may be communicated to the HVAC controller 46, so that the HVAC controller 46 may determine a size of the area that is or is not covered by frost.

In another example, the sensor 42 may be configured or programmed to sense data related to a boundary line 52 at the edge of intersections between portions of the window 26 that are covered by frost and portions that are not covered by frost. The HVAC controller 46 may then use the data related to the sensed boundary line 52 to determine a size of the area of the window 26 that is or is not covered by frost. In yet another alternative embodiment, the sensor 42 may be configured to sense or detect objects, such as a hood or body 22 line of the body 22. The HVAC controller 46 may then be able to determine the size of the area of the window 26 that is covered by frost based on the amount of the hood/vehicle 20 body 22 that is visible through the window 26 to the sensor 42, through the un-frosted regions of the window 26. It should be appreciated that the data sensed by the sensor 42, and the manner in which the sensor 42 and/or the HVAC controller 46 determines the amount of the window 26 that is covered by frost and is not covered by frost may differ from the exemplary embodiments described herein.

Once the sensor 42 has sensed the data related to the area of the window 26 that is and is not covered by frost, then the HVAC controller 46 may calculate a percentage of the window 26 that is not covered by frost, based on the data sensed by the sensor 42 related to the area of the window 26 not covered by frost. Calculating the percentage of the window 26 not covered by frost is generally indicated by box 102 in FIG. 3. The HVAC controller 46 may be pre-programmed with a total area of the window 26, so that once an area of the window 26 that is not covered by frost is sensed or determined by the sensor 42 and/or the HVAC controller 46, then the HVAC controller 46 may use simple mathematic calculations to calculate the percentage of the window 26 not covered by frost. The process of sensing the area of the window 26 not covered by frost and calculating the percentage of the window 26 not covered by frost is continuously or repeatedly executed so that the HVAC controller 46 knows the current status of the window 26.

A temperature of the engine coolant is also continuously or repeatedly sensed with a coolant temperature sensor 42 of the vehicle 20. Sensing the engine coolant temperature is generally indicated by box 104 in FIG. 3. The coolant temperature sensor 42 senses the temperature of the coolant circulating through an engine of the vehicle 20, and communicates the sensed temperature to the HVAC controller 46. The coolant temperature sensor 42, and the operation thereof are well known to those skilled in the art, and are therefore not described in detail herein. The sensed temperature of the engine coolant is used for several different vehicle 20 algorithms, and is typically available through a vehicle data BUS.

The HVAC controller 46 then compares the sensed temperature of the engine coolant to a coolant threshold temperature to determine if the temperature of the engine coolant is less than the coolant threshold temperature, or if the temperature of the engine coolant is equal to or greater than the coolant threshold temperature. The coolant threshold temperature is a pre-defined temperature that the engine coolant should reach prior to being used for heating the flow of air circulating through the HVAC system 28. Prior to the engine coolant reaching the coolant threshold temperature, all of the heat within the engine coolant should be directed toward warming the engine, and not used to warm the flow of air through the HVAC system 28. For example, the coolant threshold temperature may be defined to equal a temperature of approximately 20° C.

A cabin temperature within the passenger cabin 24 of the vehicle 20 is also continuously and/or repeatedly sensed with an air temperature sensor 42. Sensing the cabin temperature is generally indicated by box 106 in FIG. 3. The air temperature sensor 42 may be part of the HVAC system 28, and senses the air temperature within the passenger cabin 24. The air temperature is communicated to the HVAC controller 46, so that the HVAC controller 46 may compare the sensed cabin temperature to a desired cabin temperature to determine if the sensed cabin temperature is less than the desired cabin temperature, or if the sensed cabin temperature is equal to or greater than the desired cabin temperature. The desired cabin temperature is the air temperature within the passenger cabin 24 that the HVAC system 28 attempts to achieve. The desired cabin temperature is preferably a user defined value, and may be input into the HVAC controller 46 by a user, through a desired temperature setting.

The HVAC controller 46 compares the percentage of the window 26 not covered by frost to an area threshold value, to determine if the percentage of the window 26 not covered by frost is less than or equal to the area threshold value, or if the percentage of the window 26 covered by frost is greater than the area threshold value. The area threshold value is a minimum area of the window 26 that must be cleared of frost or fog before the HVAC fully switches to the cabin heating mode. For example, the area threshold value may be defined to equal between 50% and 100% of the total area of the window 26. The area threshold value may be a user defined value that is input into the HVAC controller 46, or may be a pre-defined value programmed into the HVAC controller 46.

As generally indicated at box 108 in FIG. 3, the HVAC controller 46 compares the percentage of the window not covered by frost to the area threshold value, the sensed temperature of the engine coolant to the coolant threshold temperature, and the sensed cabin temperature to the desired cabin temperature. If the HVAC controller 46 determines that the sensed cabin temperature is less than the desired cabin temperature, the percentage of the window 26 not covered by frost is less than the area threshold value, and the sensed temperature of the engine coolant is less than the coolant threshold temperature, generally indicated at 110, then the HVAC controller 46 controls the HVAC system 28 to operate in the defrost mode. Referring to FIG. 3, when the HVAC controller 46 determines that the cabin temperature is less than the desired cabin temperature, the sensed area not covered by frost is less than the area threshold, and the temperature of the engine coolant is less than the coolant threshold temperature, generally indicated at 110, then the HVAC controller 46 controls the fan 29 to operate at a first speed, generally indicated by box 111 in FIG. 3. The first speed may be defined as a 0% duty cycle of the fan 29, i.e., the fan 29 is not running at all, or may be defined to equal a duty cycle greater than 0%, but less than 100%. For example, the first speed may be defined as a 30% duty cycle of the fan 29. The HVAC system 28 may operate the fan 29 at the first speed when the temperature of the engine coolant is less than the coolant threshold temperature so that the HVAC system 28 does not draw too much heat from the engine coolant, and the engine is allowed to warm quickly.

If the HVAC controller 46 determines that the sensed cabin temperature is not less than the desired cabin temperature, the percentage of the window not covered by frost is not less than the area threshold value, and/or the sensed temperature of the engine coolant is not less than the coolant threshold temperature, generally indicated at 112, then the HVAC controller 46 determines if the sensed cabin temperature is less than the desired cabin temperature, the percentage of the window not covered by frost is less than the area threshold value, and the sensed temperature of the engine coolant is equal to or greater than the coolant threshold temperature, generally indicated by box 114 in FIG. 3. If the HVAC controller determines that the sensed cabin temperature is less than the desired cabin temperature, the percentage of the window not covered by frost is less than the area threshold value, and the sensed temperature of the engine coolant is equal to or greater than the coolant threshold temperature, generally indicated at 116, then the HVAC controller controls the fan 29 to operate at a second speed, generally indicated by box 118. The second speed is distinct from the first speed. For example, the second speed may be defined as a 100% duty cycle of the fan 29, i.e., the fan 29 operates at full speed.

So long as the percentage of the window 26 that is not covered by frost is less than the area threshold value, the HVAC controller 46 controls the HVAC system 28 to operate in the defrost mode. However, if the HVAC controller 46 determines that the sensed cabin temperature is not less than the desired cabin temperature, the percentage of the window not covered by frost is not less than the area threshold value, and/or the sensed temperature of the engine coolant is not equal to or greater than the coolant threshold temperature, generally indicated at 120, then the HVAC controller compares the sensed area that is not covered by frost to an intermediate area threshold value, generally indicated at 122. The intermediate area threshold value may be defined to equal a value between 10% and 90% of a total area of the window 26. If the HVAC controller 46 determines that the sensed area not covered by frost is equal to or greater than the intermediate area threshold value, but is less than the area threshold value, that the temperature of the engine coolant is equal to or greater than the coolant threshold temperature, and the sensed cabin temperature is less than the desired cabin temperature, generally indicated at 124, then the HVAC controller 46 may control the HVAC system 28 to operate in the split mode, i.e., to operate both the defrost mode and the cabin heating mode simultaneously, generally indicated by box 126. In so doing, once the window 26 begins to and is partially defrosted, a portion of the heated flow of air may be directed to heating the passenger cabin 24.

When the sensed area not covered by frost is equal to or greater than the area threshold value, and the air temperature within the passenger cabin 24 is less than the desired cabin temperature, the HVAC controller 46 controls the HVAC system 28 to operate in the cabin heating mode, with the fan 29 at 100% duty cycle, to heat the air within the cabin, generally indicated by box 128. The HVAC operates the HVAC system 28 in the cabin heating mode until the air temperature within the passenger cabin 24 reaches the desired cabin temperature, at which time the HVAC controller 46 controls the fan 29 to operate at a lower duty cycle, for example, a 25% duty cycle, generally indicated by box 130, until the user enters a command into the HVAC controller 46 to alter the control scheme.

The HVAC controller 46 automatically switches the HVAC system 28 from the defrost mode to the cabin heating mode when the sensed area not covered by frost increases to a value that is equal to or greater than the area threshold value. Accordingly, the switch from the defrost mode to the cabin heating mode is not based on a pre-set time, at which the window 26 may or may not be defrosted. Rather, the decision to switch from the defrost mode to the cabin heating mode is based on the current, actual conditions of the window 26. By so doing, the HVAC system 28 operates in the defrost mode only long enough to defrost the window 26, and does not spend extra time directing heated air onto the window 26 after the window 26 has been defrosted. By automatically switching from the defrost mode to the cabin heating mode when the sensed area not covered by frost is a value that is equal to or greater than the area threshold value, heat may be more quickly directed toward warming the air within the passenger cabin 24.

The method described above is particularly useful to vehicles 20 including remote start capabilities, in which the vehicle 20 may be remotely started from a portable hand held device, such as a key fob, a smart phone, tablet, or other mobile device. The HVAC controller 46 may be linked to and in communication with the portable hand held device such that the vehicle 20 may be remotely started and a desired cabin temperature may be input into the HVAC controller 46 via the portable hand held device. In so doing, a user may define the temperature they wish the passenger cabin 24 to be heated to. The HVAC controller 46 will control the HVAC system 28 as described above to first defrost the window 26, for example, the front windshield, and then automatically switch to the cabin heating mode to heat the passenger cabin 24 to the desired cabin temperature when the window 26 is defrosted. The process described above minimizes the amount of time required to defrost the window 26 and heat the passenger cabin 24 to the desired cabin temperature.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A method of controlling a Heating Ventilation Air Conditioning (HVAC) system of a vehicle, the method comprising:
repeatedly sensing an area size of a window of the vehicle that is not covered by frost with a sensor positioned adjacent the window;
controlling the HVAC system, with an HVAC controller, to operate in a defrost mode in response to the sensed area size not covered by frost being less than an area threshold value; and
controlling the HVAC system, with the HVAC controller, to operate in a cabin heating mode in response to the sensed area size not covered by frost being equal to or greater than the area threshold value;
wherein the HVAC controller automatically switches the HVAC system from the defrost mode to the cabin heating mode in response to the sensed area size not covered by frost increasing to a value that is equal to or greater than the area threshold value.

2. The method set forth in claim 1 further comprising calculating a percentage of the window that is not covered by frost with the HVAC controller, based on the sensed area size not covered by frost.

3. The method set forth in claim 1 further comprising sensing a temperature of an engine coolant with a coolant temperature sensor.

4. The method set forth in claim 3 further comprising comparing the temperature of the engine coolant to a coolant threshold temperature to determine if the temperature of the engine coolant is less than the coolant threshold temperature, or if the temperature of the engine coolant is equal to or greater than the coolant threshold temperature.

5. The method set forth in claim 4 wherein controlling the HVAC system to operate in the defrost mode includes controlling a fan to operate at a first speed in response to the temperature of the engine coolant being less than the coolant threshold temperature.

6. The method set forth in claim 5 wherein controlling the HVAC system to operate in the defrost mode includes controlling the fan to operate at a second speed, distinct from the first speed, in response to the temperature of the engine coolant being equal to or greater than the coolant threshold temperature.

7. The method set forth in claim 3 further comprising sensing a cabin temperature within a passenger cabin of the vehicle with an air temperature sensor.

8. The method set forth in claim 7 further comprising comparing the sensed cabin temperature to a desired cabin temperature to determine if the sensed cabin temperature is less than the desired cabin temperature, of if the sensed cabin temperature is equal to or greater than the desired cabin temperature.

9. The method set forth in claim 8 further comprising controlling the HVAC system to operate in both the defrost mode and the cabin heating mode in response to the temperature of the engine coolant being equal to or greater than the coolant threshold temperature, the sensed area size not covered by frost being equal to or greater than an intermediate area threshold value and less than the area threshold value, and in response to the sensed cabin temperature being less than the desired cabin temperature.

10. The method set forth in claim 9 wherein the intermediate area threshold value is between 10% and 90% of a total area of the window.

11. The method set forth in claim 1 wherein the area threshold value is between 50% and 100% of a total area of the window.

12. The method set forth in claim 1 wherein the window is a front windshield of the vehicle.

13. The method set forth in claim 1 wherein the sensor includes an optical sensor positioned within the passenger cabin for sensing objects through the window.

14. The method set forth in claim 13 wherein the optical sensor is one of a camera or a light sensor.

15. The method set forth in claim 1 wherein the vehicle includes a light source positioned outside the passenger cabin and operable to emit light through the window and into the passenger cabin, and wherein the sensor is positioned within the passenger cabin to sense light emitted from the light source.

16. The method set forth in claim 8 wherein the HVAC controller is linked to and in communication with a portable hand held device, and wherein the method includes inputting the desired cabin temperature into the HVAC controller via the portable hand held device.

17. The method set forth in claim 1 wherein the area threshold value is a user defined input into the HVAC controller.

18. A method of controlling a Heating Ventilation Air Conditioning (HVAC) system of a vehicle, the method comprising:
repeatedly sensing an area size of a windshield of the vehicle that is not covered by frost with a forward facing sensor positioned adjacent the window and within a passenger cabin of the vehicle;
calculating a percentage of the windshield that is not covered by frost, with an HVAC controller, from the area size sensed by the sensor that is not covered by frost;
sensing a temperature of an engine coolant with a coolant temperature sensor;
comparing the temperature of the engine coolant to a coolant threshold temperature, with the HVAC controller, to determine if the temperature of the engine coolant is less than the coolant threshold temperature, or if the temperature of the engine coolant is equal to or greater than the coolant threshold temperature;
sensing a cabin temperature within the passenger cabin of the vehicle with an air temperature sensor;
comparing the sensed cabin temperature to a desired cabin temperature, with the HVAC controller, to determine if the sensed cabin temperature is less than the desired cabin temperature, of if the sensed cabin temperature is equal to or greater than the desired cabin temperature;
automatically controlling the HVAC system, with the HVAC controller, to operate in a defrost mode in response to the percentage of the windshield not covered by frost being less than an area threshold value, and the temperature of the engine coolant being equal to or greater than the coolant threshold temperature; and
automatically controlling the HVAC system, with the HVAC controller, to operate in a cabin heating mode in response to the percentage of the windshield not covered by frost being equal to or greater than the area threshold value, the temperature of the engine coolant being equal to or greater than the coolant threshold temperature, and the cabin temperature being less than the desired cabin temperature;
wherein the HVAC controller automatically switches the HVAC system from the defrost mode to the cabin heating mode in response to the percentage of the windshield not covered by frost increasing to a percentage that is equal to or greater than the area threshold value.

19. The method set forth in claim 18 wherein controlling the HVAC system to operate in the defrost mode includes controlling a fan to operate at a first speed in response to the temperature of the engine coolant being less than the coolant threshold temperature, and controlling the fan to operate at a second speed in response to the temperature of the engine coolant being equal to or greater than the coolant threshold temperature.

20. A vehicle comprising:
a body defining a passenger cabin and including a window;
a HVAC system operable in a defrost mode for defrosting the window, and in a cabin heating mode for heating the passenger cabin;
an optical sensor positioned adjacent the window, within the passenger cabin, and operable to sense light through the window;
a light source attached to the body outside of the passenger cabin, and positioned to emit light through the window; and
a HVAC controller in communication with the optical sensor;
wherein the optical sensor is operable to sense data related to light emitted from the light source and transmitted through the window, and communicate the sensed data to the HVAC controller;
wherein the HVAC controller includes a processor and tangible, non-transitory memory on which are recorded computer-executable instructions, including a HVAC control algorithm operable to:
calculate a percentage of the window that is covered by frost from the sensed data received from the optical sensor; and
automatically control the HVAC system to operate in one of the defrost mode or the cabin heating mode based on the calculated percentage of the window covered by frost.
